(19) United States
(12) Patent Application Publication
(10) Pub. No.: US 2011/0295533 A1
(43) Pub. Date: Dec. 1, 2011

(54) METHOD AND DEVICE FOR CLASSIFYING A BATTERY

(75) Inventor: Denis Porcellato, Chavenay (FR)

(73) Assignee: PEUGEOT CITROEN AUTOMOBILES SA, Velizy Villacoublay (FR)

(21) Appl. No.: 13/148,181

(22) PCT Filed: Jan. 28, 2010
(86) PCT No.: PCT/FR10/50131

§ 371 Date: Aug. 5, 2011

(30) Foreign Application Priority Data
Feb. 13, 2009 (FR) 0950908

(51) Int. Cl. G06F 19/00

(52) U.S. Cl. 702/63

(57) ABSTRACT

The invention relates to a device for classifying a battery produced by assembling electricity-accumulating elements (1, 2, 3, 4, 5) divided into groups. In the device, a component (22) is provided for evaluating the degrees of ageing, each of which is associated with a distinct group, and for allocating, to the battery, in accordance with statistical distribution parameters of the evaluated degrees of ageing, a classification level that is representative of the potential performances of the battery during use.

### CROSS-REFERENCE TO RELATED APPLICATIONS

The present application is the US National Stage under 35 U.S.C. §371 of PCT/FR2010/050131 which was filed on Jan. 28, 2010 and which claims the priority of French application 0950908 filed on Feb. 13, 2009.

### BACKGROUND

The present invention relates to a method and device for classifying a battery, in particular a battery of an automotive vehicle.

During use, the battery of a vehicle gradually loses its performance, with negative consequences for the operation of the vehicle, especially for a vehicle with electrical traction.

In order to control this loss of performance, devices and methods have already been proposed to estimate the degree of deterioration of a battery.

French Pat. No. 2841385 discloses the calculation of several degrees of deterioration, each associated with a value of the detected status. The total degree of deterioration then is calculated based on the degrees of deterioration, associated with the status values. The inconvenience of the device and method disclosed in this patent is that each degree of deterioration is related to the battery as a whole.

A battery for an automotive vehicle is made in general of several modules, each consisting of several cells.

U.S. Pat. No. 7,075,194 describes a method for configuring a battery in real time by connecting the cells differently with each other as a function of the use. Parallel connection of cells is advantageous for use with high current consumption. Serial connection of cells is advantageous for use requiring high voltage.

Nevertheless, the cells do not age uniformly because aging depends on the specific thermal environment of each cell, the initial characteristics of the cells, the inaccuracy of the manufacturing process which is a source of early aging, and the situation in the vehicle which can cause an imbalance in the electrical circuit, for instance with respect to interconnection impedance.

The dispersion of the typical characteristics of each cell is amplified over time and the battery loses part or all of its performance. The loss of battery performance has a direct effect on the performance of the vehicle, on fuel consumption and consequently on the emission of greenhouse gas.

The prior state of technology involves analyzing the whole battery and evaluating its state according to overall characteristics, without taking into account the dispersion of the characteristics of its constituting cells. This approach leads to replacement of the battery when it would have been sufficient to instead replace certain cells of the battery.

It is however recommended not to abandon the knowledge of the overall characteristics of the battery and to focus only on the state of the individual cells, because the overall characteristics have a direct impact outside the battery, in particular on the operation of the vehicle.

### BRIEF SUMMARY

To remedy the inconveniences of the prior state of technology, a method is disclosed for classifying a battery made by assembling electrical storage cells divided in groups. The method comprises the steps of:
evaluating the degrees of aging associated with each distinct cell group; and
assigning to the battery, as a function of the parameters of the statistical distribution of the evaluated degrees of aging, a classification level which is representative of the potential performance of the battery when in use.

In particular, the degree of aging of at least one cell group is evaluated by an impedance measurement method or a method for estimating the internal resistance as a function of the measured current flowing through the group of cells and the measured voltage.

Advantageously, the method comprises a step of replacing at least one first group with a second group in order to maintain the classification level of the battery.

In particular, the first cell group in the battery is replaced by exchanging it with the second cell group, wherein the second cell group had been exposed to utilization stresses lower than the first cell group prior to the exchange.

More particularly, the utilization stresses comprise a temperature.

Alternatively, the first cell group is replaced with a second cell group from another battery with lower degree of aging.

Or alternatively, the first cell group is replaced with a second cell group with zero degree of aging.

Among the different possible implementation methods, a cell group can comprise all of the cells of the battery, some cells of the battery or only one cell of the battery.

By preference, the parameters of the statistical distribution comprise the average degree of aging and/or the highest value of the evaluated degrees of aging.

A device for classifying a battery assembled from electrical storage cells divided in groups. The device comprises a component arranged for:
evaluating the degree of aging of each distinct cell group;
assigning to the battery, as a function of the parameters of the statistical distribution of the evaluated degrees of aging, a classification level which is representative of the potential performance of the battery in use.

In particular, the component is arranged for evaluating the degree of aging of at least one cell group by an impedance measurement method or a method for estimating the internal resistance as a function of the measured value of the current flowing through the cell group and measurement of the voltage.

Advantageously, the device comprises slides which hold the electrical storage cells forming the battery and which allow replacing at least one first cell group with a second cell group in order to maintain the classification level of the battery.

More particularly, the component comprises means for communicating the classification level and the evaluated degree of aging.

In the device, one cell group can comprise all of the cells of the battery, some of the cells of the battery or only one cell of the battery.

By preference, the statistical distribution parameters comprise the average degree of aging and/or the highest value of the evaluated degrees of aging.

### BRIEF DESCRIPTION OF THE SEVERAL VIEWS OF THE DRAWINGS

The method and device will be better understood and other goals, characteristics, details and advantages will become clear upon reading the following explanatory description with reference to the attached schematic drawings, which are provided strictly as examples illustrating one implementation mode of the method and device, in which:

FIG. 1 is a schematic view of the device for classifying a battery;

FIG. 2 shows the steps of the method for classifying a battery;

FIG. 3 is a statistical distribution curve as a function of one characteristic value;

FIG. 4 shows an example of possible classification as a function of the displacement of the curve of FIG. 3.

### DETAILED DESCRIPTION

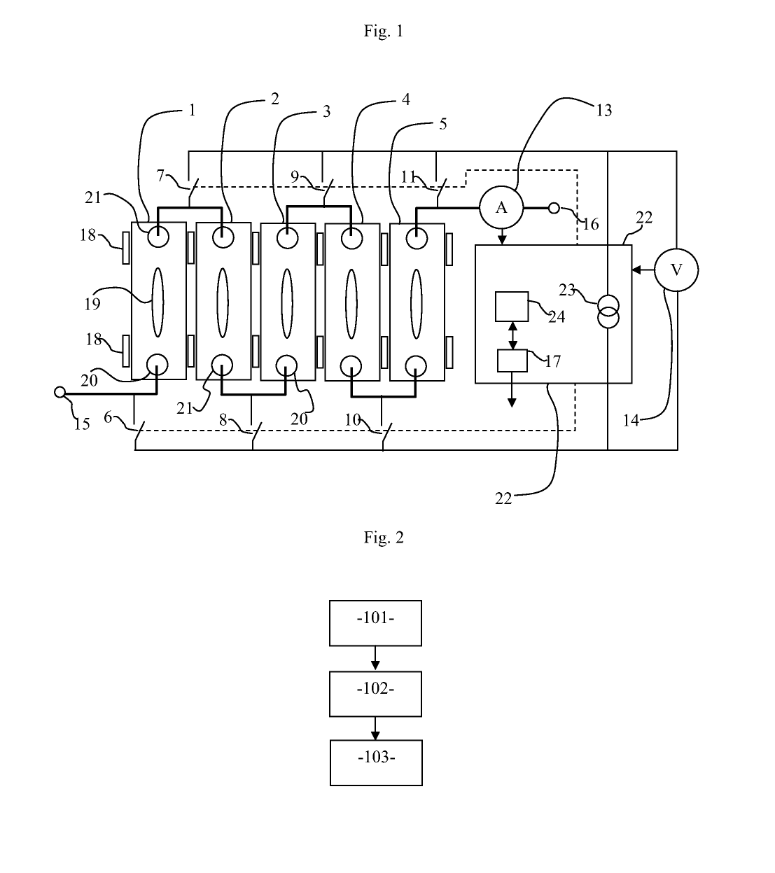

With reference to FIG. 1, a battery is assembled from electrical storage cells 1, 2, 3, 4, 5 between two output terminals 15 and 16. Each electrical storage cell 1, 2, 3, 4, 5 supplies electrical voltage and internal impedance between two contacts points 20 and 21. The electrical storage cells 1, 2, 3, 4, 5 are divided into cell groups in which the cells can be connected in parallel or in series with each other and the cell groups themselves can be connected in series or in parallel with each other.

In the example illustrated in FIG. 1, contact point 20 of one cell is connected with terminal 15 or with contact point 21 of the preceding cell. Therefore, the battery can be considered to be a group comprising five cells connected in series or five cell groups connected in series with each cell group containing only one cell. An amp meter 13 upstream of terminal 16 measures the current generated by the battery during use. Although in the illustrated example the total number of cells of the battery is five, it is clear that the total number of cells can be any number greater or smaller than five.

Each electrical storage cells 1, 2, 3, 4, 5 are inserted in rails or between slides 18, in which the cells slide easily in order to facilitate their removal, either individually or as a group.

The rails or slides 18 are mounted to the vertical walls of a compartment (not shown) on the bottom of which is pressed a bus connecting the contact point of one cell with the contact point of another cell, for instance as shown in solid line in FIG. 1. Ideally, contact points 20, 21 are directed downwards to make contact with the bus when the cells are pushed in the compartment between the slides. Contact points 20, 21 are located under the cells and are directed downward in order to avoid short circuits, especially with the lid, which is not shown. When the lid is closed on top of the compartment, it is pressed against the electrical storage cells 1, 2, 3, 4, 5 to ensure good electrical contact between bus and contact points. After opening the lid and disconnecting the cell from the bus, the cell can be lifted out by means of a handle 19 located on top of each cell. During the lifting maneuver, there is no risk of short circuiting with the other cells because the other cells are protected by the orientation of their contact points, which are directed towards the bottom the compartment.

A component 22 is arranged for implementing the process steps which will be explained now with reference to FIG. 2.

In step 101, the degree of aging of one distinct cell group is evaluated. In particular, the degree of aging of a cell group comprising a single cell is evaluated.

The degree of aging of an individual cell can be evaluated in different ways. It can be evaluated during the use of the battery by measuring the current supplied by the battery by means of amp meter 13 and by connecting a voltmeter to contact points 20, 21 to measure the voltage delivered by the cell when charged, in order to deduce the degree of aging. It can be evaluated by means of a clock measuring the time separating the present moment from a prior moment in which the cell with known degree of aging was inserted in the battery basket.

Advantageously, the degree of aging is evaluated by means of an impedance measuring method. The impedance measuring method consists in injecting a variable current with known amperage in the cell or group of cells to be checked and in measuring the resulting voltage variation at the terminals of the cell or the group of cells, respectively. The variable current is injected in such a manner that it is added, only in that cell or group of cells, to the zero or non-zero base current normally circulating through the battery. In this way, it is possible to measure the impedance of each cell or group of cells in isolation, without requiring knowledge of the zero load voltage or the voltage drop over the contact points of the cells caused by circulation of the base current.

The component 22 is arranged for injecting the variable current by means of a current generator 23. The current generator is constructed in a known manner, for instance by means of a bipolar electrical generator supplied with current by operational amplifiers, with voltage saturation safety.

In a first implementation mode (not shown), the component 22 is a portable instrument (i.e., not on board the vehicle) comprising measuring terminals, each of which is connected to one pole of current generator 23. The measuring terminals of the component 22 are then connected with contact points 10 and 21 of one cell or with the ends of one group of cells. Starting from the measured voltage variation between terminals, the component 22 calculates the impedance of the cell or group of cells, and uses the result to estimate the degree of aging, which is directly equal to or a function of the calculated impedance. The estimated degree of aging is saved in a memory 24 in association with a reference of the checked cell or group of cells. Communication means 17 indicate the degree of aging on a display. The measuring terminals of component 22 then are connected with contact points 20 and 21 of a next cell or the ends of a following group of cells.

In a second implementation mode, illustrated by FIG. 1, component 22 is on board of the vehicle. One pole of generator 23 is connected to a first series of relays 6, 8, 10 and another pole of generator 23 is connected to a second series of relays 7, 9, 11. Strictly for non-limiting illustration purposes, relay 6 in FIG. 1 is connected to a part of the bus which connects terminal 15 with contact point 20 of cell 1. Relay 8 is connected to a part of the bus which connects contact point 21 of cell 2 with contact point 20 of cell 3. Relay 10 is connected to a part of the bus which connects contact point 21 of cell 4 with contact point 20 of cell 5. Relay 7 is connected with a part of the bus which connects contact point 21 of cell 1 with contact point 20 of cell 2. Relay 9 is connected with a part of the bus which connects contact point 21 of cell 3 with contact point 20 of cell 4. Relay 11 is connected with a part of the bus which connects contact point 21 of cell 5 with terminal 16.

Component 22, on board of the vehicle, is programmed to sequentially close relays 6 and 7 in order to measure the impedance of cell 1, relays 7 and 8 in order to measure the impedance of cell 2, relays 8 and 9 in order to measure the impedance of cell 3, relays 9 and 10 in order to measure the impedance of cell 4, relays 10 and 11 in order to measure the impedance of cell 5. The impedance is measured by measuring the voltage in module and in phase by means of voltmeter 14. The degrees of aging correlated to each impedance measurement are successively saved in a relational table indexed by cell reference. The relational table is for instance saved in memory 24 of component 22. In the relational table, it is advantageous that each cell reference is related to a date expressed in terms of distance (e.g., kilometers) driven by the vehicle since the cell became part of the battery, a date expressed in terms of Amp hours exchanged by the cell or a date expressed in terms of elapsed time since the cell was put into service.

We have developed the case in which the impedance, for instance at a given current frequency which varies in alternative form, constitutes a characteristic value of the degree of aging. Other characteristic values can be envisaged, such as for instance a time integral of the temperature experienced by the cell or the cell age. On the other hand, in the case that the voltage of each cell is checked individually, for instance in the case of a Lithium-ion battery, knowing the amperage of the current passing through the cell and by measuring its voltage, the internal resistance can be calculated and used as a characteristic for estimating the degree of aging of an cell. This operation can be carried out both while driving or in park mode at the service station.

Communication means 17 is arranged for transferring information contained in memory 24, for instance towards the diagnostic port of the vehicle (not shown). Secondarily, communication means 17 is arranged for transferring information to memory 24, for instance from the diagnostic port of the vehicle.

In step 102 a classification level is assigned to the battery. During use, the potential performance of the battery depends on the totality of cells constituting the battery but also on the individual cells. To be representative, the proposed classification level takes into account these two components which determine the performance of the battery.

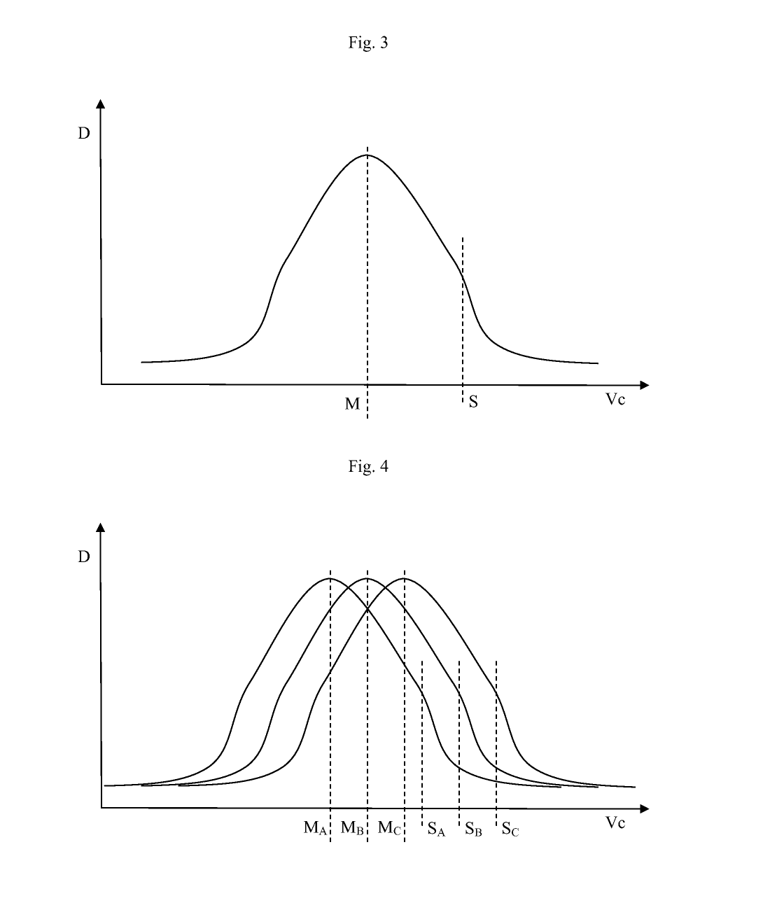

FIG. 3 shows a distribution curve D of the cells or groups of cells of a battery as a function of a variable characteristic Vc of the degree of aging. In general, the cells are distributed around the mean value M with a frequency of occurrence which is higher near the mean and decreases on both sides. The more homogenous the cell population, the more the values of the variable characteristic will be grouped around the mean. Inversely, the more heterogeneous the cell population, the more the characteristic variable will be dispersed with the effect of flattening the curve centered on the mean.

Considering degrees of aging for which the variable characteristic is the cell impedance, the age of the cell or the number of charge and discharge cycles, the performance will be higher for the lower values of the variable characteristic on the left of the curve and lower for the higher values of the variable characteristic on the right of the curve.

Component 22 contains an arithmetic and logical unit and a few lines of code for calculating the mean M of the values contained in memory 24 and measured in the preceding step.

Component 22 holds in memory 24 the possible mean values M_{A}, M_{B}, M_{C}. With reference to FIG. 4, the distribution of the cells corresponding to the mean value M_{A} is statistically represented by the left curve. The best battery performance can be expected from a classification level which corresponds with statistical distribution D with mean M_{A}, because the values of the variable characteristic Vc, representing the degree of aging, are mostly lower values. The distribution of cells with mean value M_{c} is statistically represented by the right curve. Fair battery performance can be expected from a classification level corresponding with statistical distribution D with mean M_{c}, because the values of the variable characteristic Vc, representing the degree of aging, are mostly higher values. The distribution of the cells with mean value M_{B} is statistically represented by the middle curve. The statistical distribution of D with average M_{B} corresponds to a classification level that may be expected in performance using the battery less than those obtained with an average M_{A} average but better than those obtained with the average M_{C}.

Component 22 contains a few lines of code for comparing the calculated mean value M with possible values M_{A}, M_{B}, and M_{c} within a predetermined tolerance range, in order to attribute a classification level NC to the battery, by using formulas of the following type:

$$M < \frac{3 {M}_{A} + {M}_{B}}{2} ⇒ NC := A$$

$$\frac{3 {M}_{A} + {M}_{B}}{2} \leq M < \frac{3 {M}_{B} + {M}_{C}}{2} ⇒ NC := B$$

$$\frac{3 {M}_{B} + {M}_{C}}{2} \leq M ⇒ NC := C$$

A supplementary condition can be imposed, for instance that in addition to the mean falling within one of the above defined intervals, no cell characteristic may exceed a certain threshold.

If the classification level is A, B or C, respectively, and component 22 detects a cell with variable characteristic greater than a threshold S_{A}, S_{B}, or S_{c}, respectively, component 22 generates an alarm and communicates the reference of the cell with the characteristic value which is too high for the class in which it is classified.

The number of classification levels can be higher than three. The classification can be based on other methods than those based on the mean of the variable characteristic monitored for the different cells or groups of cells constituting the battery and where each class corresponds to a value interval of this characteristic.

Another example is a method in which the classification is based on the characteristic value of the weakest cell or on the average of the x weakest cells. There are also other classification methods.

If the check shows that the battery has transitioned from class A (new battery) to class B, the user has the choice of accepting the declassification of the battery or requesting an exchange of the weakest cells in order to keep the battery in class A.

If the check shows that the battery is classified C, the client has the choice of accepting this classification of the battery or requesting an exchange of the weakest cells in order to keep the battery in class B or even to upgrade the battery to class A.

In step 103 the faulty cells are replaced with cells which were already in service and which were recycled and classified in advance as level a, b, c and were designated as being the most suitable to be integrated in a battery with a respective classification level A, B, C.

Consider the example of a cell retrieved in order to keep the battery in class A. The monitored characteristic of this cell showed an aging state greater than the criterion for class A. Let's assume that this cell is class b. This cell can be used later to upgrade a battery from class C to class B.

The standard exchange of cells or groups of cells by new or reused cells is facilitated by the mechanical construction of the battery basket shown in FIG. 1, which is optimized for volume, weight and safety.

The individual check of each cell or group of cells and the design of the battery basket facilitates the replacement of the most degraded cells or groups of cells, ensures that the battery performance can be maintained at the highest level. By retrieving the most degraded cells from the battery, during the life of the battery, all cells will age in homogeneous manner.

For instance, in the case of a Lithium-ion battery, there is a requirement that during the discharge of the battery, a low voltage threshold is not exceeded for each cell from which the battery is made and that during the charge a high voltage threshold is not exceeded for each cell. Consequently, the cell with, for instance, the highest impedance or internal resistance will limit the capacity of the Lithium-ion battery. For this reason, it is important to have a chart of the characteristics linked to the performance of each cell from which the battery is made in order to be able to exchange the cells limiting the overall performance of the battery.

On the other hand, the thermal environment of each cell can vary significantly from one cell to another, depending on the location of the battery and the particular cell in the vehicle, and consequently the degree of aging of each cell can be very different. One solution comprises changing the cells that are most degraded by temperature. Another solution is to periodically exchange, through preventive maintenance, the cells from the hottest locations, for instance the cells that are closest to the engine, with cells from the coldest locations, for instance the most remote from the engine, in order to achieve the most homogeneous aging of the battery. This is facilitated by checking each individual cell or each group of cells and designing a battery basket which allows the exchange of the cells.

1. A method for classifying a battery assembled from electrical storage cells divided in cell groups, comprising steps consisting of:
evaluating the degree of aging of each distinct cell group;
assigning to the battery, as a function of the parameters of the statistical distribution of the evaluated degrees of aging, a classification level representing the potential performance of the battery when in use;
wherein the degree of aging of at least one cell group is evaluated through an impedance measurement method as a function of the measurement of the current flowing through the at least one cell group and measurement of the voltage.

2. The method according to claim 1, wherein the method comprises a step:
replacing at least one first cell group with a second cell group in order to maintain the classification level of the battery.

3. The method according to claim 2, wherein the first cell group is replaced, through permutation in the battery, by the second cell group which was exposed, prior to permutation, to less utilization stress than the first cell group.

4. The method according to claim 3, wherein the utilization stress comprises a temperature.

5. The method according to claim 2, wherein the first cell group is replaced with a second cell group originating from another battery with lower degree of aging.

6. The method according to claim 2, wherein the first cell group is replaced with a second cell group with zero degree of aging.

7. The method according to claim 1, wherein one cell group comprises all of the cells of the battery.

8. The method according to claim 1, wherein one cell group comprises only one cell of the battery.

9. The method according to claim 1 wherein the parameters of the statistical distribution comprise the average degree of aging and/or the highest value of the evaluated degrees of aging.

10. A device for classifying a battery assembled from electrical storage cells which are divided in cell groups, each cell group comprising one or more cells of the battery, the device comprising a component arranged for:
evaluating the degree of aging of each distinct cell group;
assigning to the battery, as a function of the parameters of the statistical distribution of the evaluated degrees of aging, a classification level which is representative of the potential performance of the battery during use;
wherein the component is arranged for evaluating the degree of aging of at least one cell group through an impedance measurement method as a function of the measurement of the current flowing through the at least one cell group of cells and measurement of the voltage.

11. The device according to claim 10, wherein the device comprises slides adapted to hold the electrical storage cells from which the battery is assembled and which allow for replacing at least one first cell group with a second cell group in order to maintain the classification level of the battery.

12. The device according to claim 10 wherein the component comprises means for communicating the classification level and the evaluated degree of aging.

13. The device according to claim 10 wherein one cell group comprises all of the cells of the battery.

14. The device according to claim 10 wherein one group comprises only one cell of the battery.

15. The device according to claim 10 wherein the parameters of the statistical distribution comprise the average degree of aging and/or the highest value of the evaluated degrees of aging.
